(19) United States
(12) Patent Application Publication
(10) Pub. No.: US 2011/0203122 A1
(43) Pub. Date: Aug. 25, 2011

(54) Kct injury prevention chain saw

(76) Inventor: Lyndon Henry Holcomb, Port Lavaca, TX (US)

(21) Appl. No.: 12/660,045

(22) Filed: Feb. 19, 2010

(51) Int. Cl. B27B 17/02; B27B 17/14

(52) U.S. Cl. 30/382; 30/386; 30/520

(57) ABSTRACT

A chainsaw that increases the level of operator safety by reducing or eliminating cut through and kickback injuries without impeding cutting operations, and increases operator comfort through ergonomics, therefore extending stamina. This is accomplished by a dual stage multi-hinged bar device that physically inhibits kickback and cut through injuries. The device, which returns to it's original position after cutting, will open up a total of 88 degrees to allow for cutting of items that are larger than the length of the guide bar. Relocation of the handles leads users toward physically holding the saw in such a manner that creates an ergonomically advantageous body position, reducing fatigue and strains. The body of the saw and the bar device will rotate 45 and 90 degrees both right and left while the operators grip on the saw remain in the same position. The chainsaw also incorporates an easy to use chain adjustment.

### RELATED APPLICATIONS

The present application is related to U.S. Pat. No. 5,666,733, issued Aug. 16, 1997, for GUIDEBAR FOR A MOTOR CHAINSAW, included by reference herein.

The present application is related to U.S. Pat. No. 4,294,012, issued Oct. 13, 1981, for CHAINSAW ANTI-PINCH GUARD ARM, included by reference herein.

The present application is related to U.S. Pat. No. 7,140,114 B2, issued Nov. 28, 2006, for GUARD FOR CHAINSAW, included by reference herein.

The present application is related to U.S. Pat. No. 5,237,752, issued Jul. 24, 1993, for MOVABLE CONTROL HANDLE FOR CHAINSAW, included by reference herein.

The present application is related to United States patent number US 2006/0248734 A1, issued Nov. 9, 2006, for CHAINSAW KICKBACK PROTECTION DEVICE, included by reference herein.

### FIELD OF THE INVENTION

The present invention relates to chainsaw operations and, more particularly, to reducing or eliminating injuries now common to chainsaw operations.

### BACKGROUND OF THE INVENTION

Since the invention of the chainsaw, there have been continuous injuries resulting from the operation of them. The majority of serious injuries can be divided into two basic categories. “Cut Through” and “Kickback” injuries. “Cut Through” injuries occur when the operator cuts through the material he or she is cutting and into their own lower extremities, generally their left upper thigh or lower legs or feet. However, injuries caused by kickback are often even more horrific. “Kickback” injuries can occur at almost any time.

Chainsaws can kickback so suddenly and violently that chainsaw users cannot possibly control the saw when this happens as most kickback events generally occur within 2/10ths of a second. When severe kickback does occur, the operator is either injured or is simply fortunate that an injury did not occur. Either way, the operator has little or no control over neither the event itself, nor the end results. However, there are two things that we can be sure of: 1) despite some operators best intentions to prevent kickback, kickback often occurs; and 2) when severe kickback does occur, it is often with frightening consequences, at times resulting in disfiguring or debilitating injuries and even fatalities.

Identifying the Root Cause of “Kickback” Injuries:

“Kickback” occurs when the saw kicks back, and usually up, as a result of the saw blade coming in contact with an object while it is spinning, especially when the front of the saw blade strikes an object while the saw is running at or near full speed. Chainsaws can also kickback sideways if cutting sideways or down if using the top of the blade. As the “blade” is a chain, bristling with sharp teeth designed to cut the hardest wood, and traveling at speeds up to 68 mph, these injuries are often extremely serious. Kickback injuries can occur on almost any part of the body, because when severe kickback occurs the operator loses his grip, if not total control of the chainsaw.

The result is a fully operational chainsaw being thrown back toward the operator. The fact is that most users do not hold chainsaws in such a manner that would help inhibit kickback and cut through injuries even when instructed to do so immediately prior to use. In fact, there isn't really a safe way to handle a chainsaw which would effectively prevent those types of injuries, because the problem is due to poor ergonomic design of the saw itself. Even those operators whom start out by holding the saw with a sturdy grip, left arm straight with their elbow locked, soon gravitates away from this more desirable body position due to fatigue or because they must constantly change body position in order to make difficult, angled, hard to reach cuts.

Consequently, it is counterproductive to try to implement training which encourages chainsaw operators to consistently use a specific body position to prevent injuries, because that in itself is not possible due to the operator having to constantly change positions with both the saw and his body. So better body positioning could not prevent injuries, due to the fact that chainsaws are designed so poorly with respect to ergonomics and operator safety. In fact, statistics show that chainsaws are the single most dangerous hand tool used by modern man. There are an estimated 40,000 chainsaw injuries each year. That equates to one chainsaw injury every 12 seconds or each workday. Clearly, attempting to training operators to hold the saw in a specific way has not resulted in a reduction of injuries.

One problem is that operators also tend to focus on cutting and forget that they are operating the most dangerous hand tool ever created, if they were ever aware of that fact in the first place. Another problem is that operators must hold chainsaws away from the body using only arm strength to control the saw, resulting in operators having limited control over the saw from the very beginning of cutting operations.

Identifying the Cause of “Cut Through” Injuries

Because the design of the saw itself dictates that the saw must be held at approximately a 45 degree left angle from the center of the operators body, cut through injuries are always a possibility, but at times when operators are fatigued they tend to angle the saw even further left and closer to their body, the possibility of cut through injuries to the upper left thigh, and elsewhere on the lower extremities increases as chainsaw operators begin griping the saw less tightly and even further out of the already unnatural position that they must use to hold the saw, due to the poor ergonomic design of the saw itself.

The main contributing factor to “Cut Through” injuries to the lower extremities is the positioning of the two handles that operators must hold onto when operating a chainsaw. The handle at the rear end of the chainsaw, where the speed control is located, is misplaced causing the operator to hold the rear of the saw out away from, and towards the right side of his body. The position of the bar handle at the left side of the saw is also part of the overall problem. When an operator grips the saw by the handles provided for him to do so, the chain naturally sets dangerously close to the left leg of the operator, and is the direct result of the poor positioning of the two handles.

This position becomes even more pronounced and hazardous when the operator becomes fatigued. It is at this time that the operator tends to bring the saw closer to the body which in turn angles the chainsaw even further left; i.e., the operator brings the right hand/rear handle of the saw toward the right side of the waist and brings the left hand closer to the body so as to relieve muscle strain the in arms, shoulder, and back. The longer the operator uses the saw, the more this is compounded because of the ever increasing fatigue of holding the saw out away from the body utilizing only arm strength. The fact is clear, the more fatigued an operator becomes the more he tries to bring the saw closer to his body and shifts his weight by moving his left leg forward and his right leg back, resulting in the chain becoming even closer to his left leg.

The Chain Brake

Low Kickback Chains

Guide bar nose protector

Protective bar over top of saw chain

The Chain Brake which is located in front of the front bar handle is only practical if you succumb to the notion that kickbacks are inevitable. The chain brake is located where it is so that when the saw kicks back and is hurled back toward the operator, his left hand may possibly disengage the chain as the saw flies by him. This is the current attitude because in cases of a kickback event, the event is usually over before it is even possible for the operator to physically react. (two tenths of a second)

Low Kickback Chains are designed to reduce kickback and therefore kickback injuries. While these chains do tend to reduce kickback forces, they do not eliminate them entirely, and kickback remains an ongoing and dangerous problem. Low kickback chains also reduce the cutting ability of the chain and therefore the saw.

The Guide bar nose protector is an inadequate solution to preventing kickback. While it does prevent the end of the chain from contacting other objects, it's very design limits the ability of the saw to fully function. The result is that with the device in place cutting operations are generally limited to limbing and bucking operations of small limbs. Consequently, most operators remove the device sooner or later during chainsaw operations, and it soon becomes an afterthought, is lost or even thrown away.

There are several variations of a protective bar over top of saw chains. All are reactionary devices. The designers are resigned that kickback will occur, and when it does, it is hoped that the device will prevent injury by shielding the operator from the top of the chain when the saw kicks back onto the operator. The problem of kickback isn't addressed, only the result.

### SUMMARY OF THE INVENTION

In accordance with the present invention, there is provided a chainsaw that increases the level of operator safety by reducing or eliminating cut through and kickback injuries without impeding cutting operations, while increasing operator comfort through ergonomics and therefore extending the operators stamina and control of the chainsaw over prolonged cutting operations. This will be accomplished in part by placing a barrier under the chain in the form of a dual stage spring actuated multi-hinged bar that serves to physically inhibit both kickback and cut through injuries, and relocation of the handles that serve to lead users toward physically holding chainsaws in such a manner during operation, that simply holding the chainsaw itself creates an ergonomically advantageous body position, which also helps prevent kickback and cut through injuries, as well as prevents the muscle fatigue and strains which cause operators to gravitate toward ever more dangerous body positions while operating chainsaws.

The body of the saw and the barrier bar will rotate 45 and 90 degrees both right and left while the handles and therefore the operators grip on the saw remains the same. The bar will have two rows of dorsal shaped teeth that will work in conjunction with the springs on the device to hold the object being cut firmly between the device and the chain. When engaging an item to be cut, the first stage of the dual stage multi-hinge bar will deploy first, followed by the second stage. When both stages are deployed, the device will open up a total of 88 degrees to allow for cutting of logs and trees that are larger in diameter than the length of the guide bar and chain. Both stages will have springs that will cause the device to close as the cut is being made, and at the completion of the cut the device will return to it's original position.

The second stage will also have a cylinder which operates on ambient air and has a spring return piston. During normal cutting operations, the cylinder will simply open and close along with the second stage of the device as is deployed. A flow control valve attached to the cylinder will seize the piston when the device is subject to the sudden force that is created during a kickback event. The instant stoppage of any upward movement of the saw by the cylinder, coupled with the log being held in place between the guide bar and the device bar by spring force and the teeth on the bar itself will stop any backward movement.

The presence of the bar itself prevents any cut through injuries from occurring. Because the saw rotates while the handles stay in the same place, the kickback motion arrest capabilities of the bar device will be accomplished without regards to which direction the cut is being made. The chainsaw also incorporates a chain adjusting device that makes adjusting the chain extremely simple and easy. The guide bar is attached onto a plate via three studs. The plate slides into a corresponding track built into the chainsaw. The plate itself moves forward and back via a worm and pinion gear that is turned by a knob to adjust tension on the chain. The saw has a gearbox that contains an oil environment operated centrifugal clutch and three mechanical gears. The gearbox protects the gears and the oil environment operated centrifugal clutch from corrosion, rust and debris. The gear arrangement serves to lower the guide bar and chain so that it sits 3/32 of an inch above the anti-kickback/cut through device. This in turn positions the anti-kickback/cut through device bar at a lower point, making it easier for the operator to slide the bar under logs on the ground.

It would be advantageous to provide a chainsaw which prevents kickback and cut through injuries.

It would also be advantageous to provide a chainsaw that creates an ergonomically advantageous body position that decreases operator fatigue and therefore extends stamina.

It would also be advantageous to provide a chainsaw that tilts both right and left while maintaining the handles in the same position.

It would also be advantageous to provide a chainsaw that allows for simple and easy chain adjustment.

It would further be advantageous to provide a chainsaw that does not impede normal operations while providing the above advantages.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a right view of a chainsaw with stage one and two of the anti-kickback/cut through device retracted;

FIG. 2 is a right view of a chainsaw with stage one of the anti-kickback/cut through device deployed;

FIG. 3 is a right view of a chainsaw with stage one and two of the anti-kickback/cut through device deployed;

FIG. 4 is a right perspective view of a chainsaw with stage one of the anti-kickback/cut through device deployed;

FIG. 5 is a right perspective view of a chainsaw with the the incremental rotational control rotated 45 degrees to the right;

FIG. 6 is a right perspective view of a chainsaw with the the incremental rotational control rotated 90 degrees to the right;

FIG. 7 is a right perspective view of a chainsaw with the the incremental rotational control rotated 45 degrees to the left;

FIG. 8 is a right perspective view of a chainsaw with the the incremental rotational control rotated 90 degrees to the left;

FIG. 9 is a detail view of a bar handle in relation to the chainsaw body;

FIG. 10 is a rear exploded view of a saw body, the incremental rotational control components, right rear handle with throttle control, and torso pad;

FIG. 11 is a right exploded view of an incremental rotational control components, right rear handle with throttle control, and torso pad;

FIG. 12 is a right detail view of a rear handle with adjustable horizontal extension sections. the inside section is attached to the incremental rotational control;

FIG. 13 is a detail view of an outside section of the rear handle and throttle control;

FIG. 14 is a detail view of an inside adjustable section of the rear handle;

FIG. 15 is a right exploded view of a gearbox, gears, oil environment centrifugal clutch, chain adjustment mechanism, guide bar with chain, guide bar plate, guide bar plate adjustment slot, and the gearbox cover;

FIG. 16 is an exploded view of a gearbox, gears, oil environment centrifugal clutch, chain tension adjustment mechanism, guide bar plate, guide bar plate slot, gearbox reservoir cover plate, gearbox oil fill plug, and the chain sprocket;

FIG. 17 is an exploded view of a guide bar plate, guide bar and chain, and nuts;

FIG. 18 is an exploded view of a saw body, gearbox cover, and the bottom mold;

FIG. 19 is a detail view of a compression springs, compression spring protector sleeves, bottom mold with the anti-kickback/cut through device with stage one deployed;

FIG. 20 is a right detail view of a bottom mold, anti-kickback/cut through device telescoping rod back stop, forward facing spikes on the bottom mold, forward facing spikes on the anti-kickback/cut through device bar, front hinge connector rods, rear facing dorsal spikes on the anti-kickback/cut through device bar, rear bar hinge, ambient air cylinder/flow control valve, ambient air cylinder/flow control valve cover, and ambient air cylinder/flow control valve cover screws;

FIG. 21 is a detail view of a bottom mold with the forward facing spikes on the bottom mold, front hinge connector rods, spiral wound torsion spring, spiral wound torsion spring cover, ambient air cylinder/flow control cover, and the rear section of the anti-kickback/cut through device bar hinge; and

FIG. 22 is an exploded view of a FIG. 22 is an exploded view of the rear section of the anti-kickback/cut through device bar, ambient air cylinder/flow control valve, and ambient air cylinder cover and screws.

For purposes of clarity and brevity, like elements and components will bear the same designations and numbering throughout the Figures.

### DESCRIPTION OF THE PREFERRED EMBODIMENT

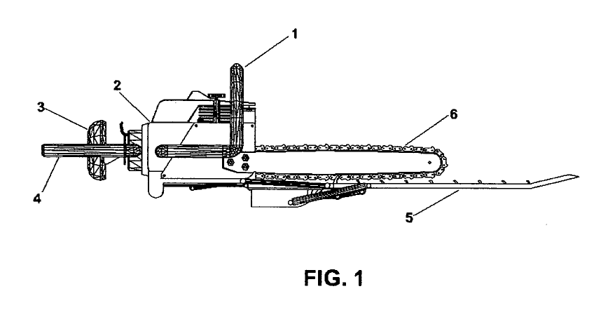

FIG. 1 is a is a right view of the chainsaw with stage one and two of the anti-kickback/cut through device 5 in the closed position. The bar handle 1 represents a significant part of an overall system that begins with repositioning and redesigning both handles in order to better maintain control of the saw, and help combat the fatigue and muscle strain that arises during continuous use of the chainsaw. The rear handle 4 is repositioned and is attached to the right rear side of the saw, and the throttle control 13 is located on the rear handle 4.

The rear handle 4 is a two piece telescoping adjustable aluminum tube that extends past the operators right waist, then turns 90 degrees back and continues for approximately another five inches. The rear handle 4 is adjustable to the waist size of each individual operator. This places the rear handle 4 in a position where the operator can grip it without moving his arm very far from where it hangs naturally so that the operator can grip the saw without causing the saw to swing left, which is contributing factor to cut through injuries. This helps place an easier load between the shoulders, balances the saw, and shortens the distance between the handles (forward and back) while increasing the distance (side to side) so that when the operator holds the saw; it is positioned closer to, and straightforward from the center of the operator's body.

The handle realignment will help prevent cut through injuries, which generally occur to the left side of the lower extremities due to current chainsaw designs that puts the blade at approximately a forty five degree angle from front center of the operators body. The weight redistribution resulting from the handle realignment will increase control, and help combat the fatigue and muscle strain that arises during continuous use of the chainsaw. The relocation of the handles also presents an opportunity to create a body position in relation to the saw that will naturally inhibit kickback and cut through injuries. This position gives the operator greater control, and naturally increases operator comfort, and therefore endurance. By simply repositioning the handles, shortening and widening the operators grip points on the saw and adding a torso pad 3, we have caused the operator to hold the saw low, and closer to the body. In turn, we now have created a body position that decreases the risk of kickback, operator fatigue and back strain during continuous operations, and since the blade is now pointed straight away from the operator, the threat of cut through injuries is also significantly reduced.

The torso pad 3 is a small circular/convex pad, aligned center to the saw, approximately six inches in diameter, located on the back of the saw body 2, where the rear handle 4 was previously located. Operators can wedge the the torso pad 3 and therefore the back of the saw against his torso at approximately the waist area whenever possible. The operator will not always be able to use the torso pad 3, but when used, will stabilize the saw by bracing it against the operators torso. The torso pad 3 is spring mounted on a single pin through the center of the rear of the saw which will allow the pad to rotate in a clockwise/counter clockwise motion. The torso pad pin spring 11 mount has approximately three inches of travel in order to counter vibration and any kickback motions of the saw against the torso. Positioning the saw at a lower axis for operation and bringing it closer to the body, will naturally straighten out both arms and lock the left elbow, which is one key in preventing kickback.

The guide bar 6 on FIG. 1 has three holes for mounting onto three studs that is attached to the guide bar mounting plate 17. The guide bar mounting plate 17 slides into the guide bar plate adjusting slot 18 and when all the way back, allows the chain to be looped over the chain sprocket 20. The chain is then tightened by turning the knob on the chain tensioning adjustment mechanism. This chain tension adjustment mechanism 25 is a worm and pinion gear that sets between the guide bar plate adjusting slot 18 and the chain sprocket 20. This will eliminate slack common to current designs of guide bars with sliding adjustment slots that become worn and loose over time. Because of the guide bar mounting plate 17 design, operators will no longer have to carry tools with which to loosen and tighten nuts in order to adjust chain tension.

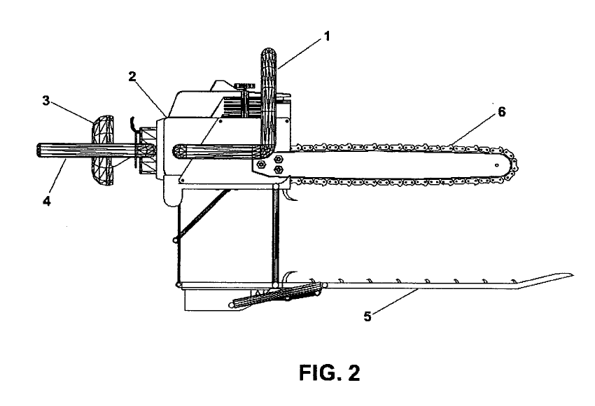

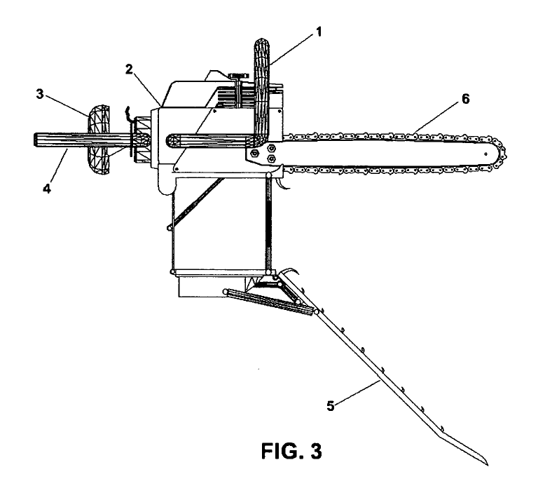

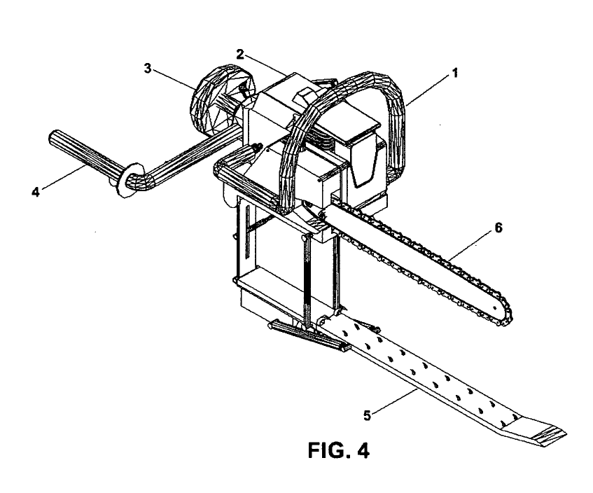

On FIG. 1, the anti-kickback/cut through device 5 is shown closed. The anti-kickback/cut through device 5 bar is made of aluminum. This is a multi-hinged two stage device and FIG. 2 is a right view of the chainsaw with stage one of the anti-kickback/cut through device 5 deployed. FIG. 3 is a right view of the chainsaw with stage one and two of the anti-kickback/cut through device 5 deployed. FIG. 4 is a right perspective view of the chainsaw with stage one of the anti-kickback/cut through device 5 deployed. The overall length of the anti-kickback/cut through device 5 will be determined by two factors: One, the length of the chain guide bar 6. Two, the distance between the front and back hinge mounts on the bottom of the saw body 2, plus an additional six inches of length. One hinge point will be located at the bottom front of the saw body 2, and the other hinge point will be located at the bottom rear of the saw body 2. The forward end of the anti-kickback/cut though device bar rises a total of one inch over the last six inches of the bar, and the front section of the bar from the anti-kickback/cut through device bar hinge 42 that is located immediately in front of the front hinge connector rods 30 is oval around the edges. This will aid the operator in sliding the bar under logs on the ground. The rear hinge assembly will consist of a spiral wound torsion spring 41 mounted in a canister on the bottom mold 27 at the rear of the saw body 2. The canister will be no larger than 1¼ inches OD. The spiral wound torsion spring 41 will be centered in the canister on an arbor, and spiral clockwise from center. The end of the spiral wound torsion spring 41 will connect to the back of the anti-kickback/cut through device 5 bar via a slotted connector to the anti-kickback/cut through device rear bar hinge 34.

The spiral wound torsion spring canister 43 will be slotted from horizontal to approximately 90 degrees downward on the forward end in order for the spring to operate. The spiral wound torsion spring 41 will keep the anti-kickback/cut through device 5 up and forward against the bottom of the saw and guide bar 6 when not in use. When the anti-kickback/cut through device 5 is engaged, the spiral wound torsion spring 41 will allow stage one of the anti-kickback/cut through device 5 to swing back and down. The spiral wound torsion spring 41 will also serve to keep the log or tree wedged between the anti-kickback/cut through device 5 and the blade of the saw, and to continuously push the anti-kickback/cut through device 5 back up into the closed position as the cut is being made.

The front hinge of the anti-kickback/cut through device 5 will consist of two front hinge connector rods 30. The top of the front hinge connector rods 30 will be attached to the bottom mold 27 of the saw on a pivot mount and the bottom of the front hinge connector rods 30 will attach onto the sides of the anti-kickback/cut through device 5 bar. There will be a telescoping back stop rod 40 attached on the bottom of the bottom mold 27 via a sliding bar fitted into a slot in the bottom mold 27. The other end of the telescoping back stop rod 40 attaches to the spiral wound torsion spring 41 connector half way between the spiral wound torsion spring 41 and the anti-kickback/cut through device rear bar hinge 34 on the back of the anti-kickback/cut through device 5 bar. This telescoping back stop rod 40 will keep the anti-kickback/cut through device 5 from opening any further than the intended design. This represents stage one of the two staged anti-kickback/cut through device 5.

This is how stage one of the anti-kickback/cut through device 5 will work. The operator will slide the end of the of the anti-kickback/cut through device 5 bar under the bottom of the tree or limb to be cut and slide the saw forward till the end of the chain almost contacts the tree or limb. The operator will then pull up on the saw, opening stage one of the anti-kickback/cut through device 5, and continue to slide the saw forward until the tree or log is firmly against the forward facing spikes on the bottom mold 28 at the bottom of the body of the front of the saw, and firmly against the forward facing spikes on anti-kickback/cut through bar 35. With very little experience, engaging the item to be cut can be accomplished in one single fluid motion.

At this point, the tree or log will be sitting on the rear facing dorsal spikes on the top of the anti-kickback/cut through device 5 bar. Now the operator can begin his cut. As the cut is being made, the spiral wound torsion spring 41 will force stage one of the anti-kickback/cut through device 5 closed. Kickback will be partially prevented by the rear facing dorsal spikes along the top of the anti-kickback/cut through device 5 bar that will inhibit the saw from being kicked back during a kickback event by digging into the tree or log being cut. The pressure of the spiral wound torsion spring 41 will partially inhibit any upward kickback motion by the saw. When stage one of the anti-kickback/cut through device 5 is fully hinged open, the forward six inches of length of the anti-kickback/cut through device 5 will aid in inhibiting the front of the chain from contacting another object which could cause kickback. The presence of the anti-kickback/cut through device 5 itself will physically prevent any cut through injuries from occurring. Generally, on a chainsaw with a fourteen inch guide bar 6, the opening of stage one of the anti-kickback/cut through device 5 will be approximately eight inches. This dimension will change depending on the guide bar 6 length of each saw.

As operators will obviously be cutting logs and trees of larger diameter than the stage one opening of the saw, there will be a second stage of the anti-kickback/cut through device 5 which will open downward up to a total of 88 degrees from the blade of the saw at the anti-kickback/cut through device bar hinge 42 that is located immediately in front of the front hinge connector rods 30. FIG. 3 is a right view of the chainsaw with stage one and two of the anti-kickback/cut through device 5 deployed. The second stage will consist of two compression springs 31, each covered with a compression spring protector sleeve. The forward end of the compression springs 31 will be mounted onto the side of the anti-kickback/cut through device 5 bar approximately five inches forward of the anti-kickback/cut through device bar hinge 42 which is located slightly ahead of where the front hinge connector rods connect to the anti-kickback/cut through device 5 bar. The rear mount of the compression springs 31 will attach onto the ambient air cylinder/flow control valve cover 33 that is located under the rear of the anti-kickback/cut through device 5. The spiral wound torsion spring 41 and the compression springs 31 will be calibrated so that the first stage of the anti-kickback/cut through device 5 will fully open, before the second stage opens.

This is how stage two of the anti-kickback/cut through device 5 will work. When stage two of the anti-kickback/cut through device 5 is deployed, the downward motion of the anti-kickback/cut through device 5 bar will depress the ambient air cylinder/flow control valve 37 piston rod on the ambient air cylinder/flow control valve 37. The ambient air cylinder/flow control valve 37 assembly, which is located under the rear section of the anti-kickback/cut through device 5, will at most times, simply travel along as the second stage is opened and closed without interference with the operation. However, when either stage one or two of the anti-kickback/cut through device 5 is subject to the sudden force that is created in a kickback event, the ambient air cylinder/flow control valve 37 will seize the cylinder and therefore the anti-kickback/cut through device 5, therefore instantly arresting the upwards kickback motion. The initial rear kickback motion created by the event will cause the rear facing dorsal spikes on the anti-kickback/cut through device bar 36 to dig into the log or tree being cut, therefore arresting the backwards motion. Once the kickback event is over, the flow control valve will release the anti-kickback/cut through device 5 so the operator can continue with the cutting operation.

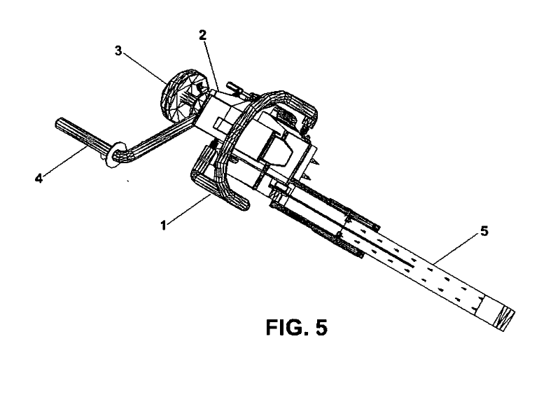

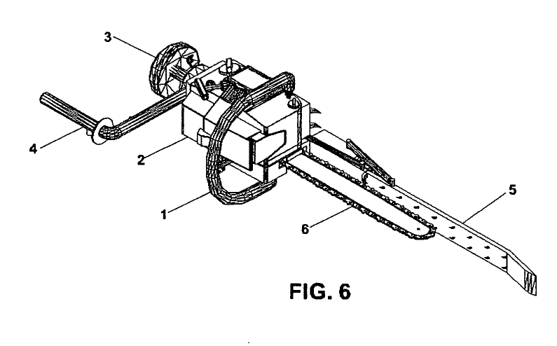

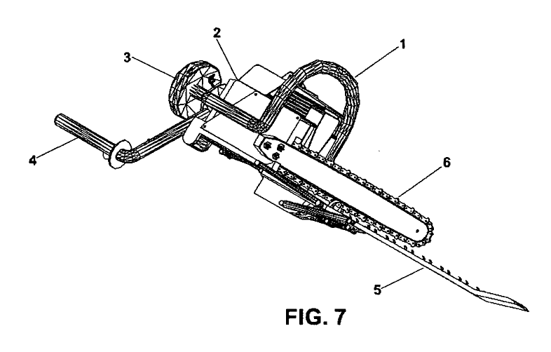

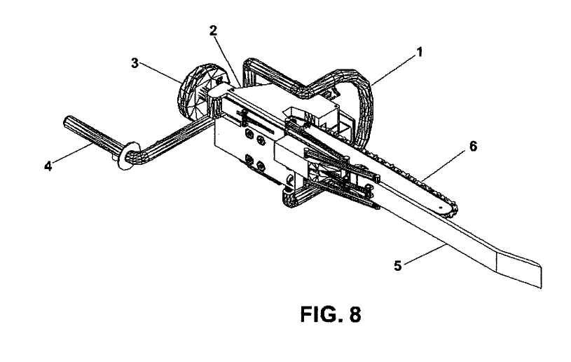

During cutting operations with or without a kickback event, and when both stages are deployed, as the cut is being made, the second stage will naturally close first, followed by the first stage. At the completion of the cut, the anti-kickback/cut through device 5 will be once again be reset to it's original position. Since the body of the saw is now designed to rotate via the incremental rotational control 9, the bar will remain under the blade at all times as the device itself rotates along with the body of the saw when making angled cuts of 45 and 90 degrees to either the right or left. FIG. 5 is right perspective view of the chainsaw with the the incremental rotational control 9 rotated 45 degrees to the right. FIG. 6 is right perspective view of the chainsaw with the the incremental rotational control 9 rotated 90 degrees to the right. FIG. 7 is right perspective view of the chainsaw with the the incremental rotational control 9 rotated 45 degrees to the left. FIG. 8 is right perspective view of the chainsaw with the the incremental rotational control 9 rotated 90 degrees to the left.

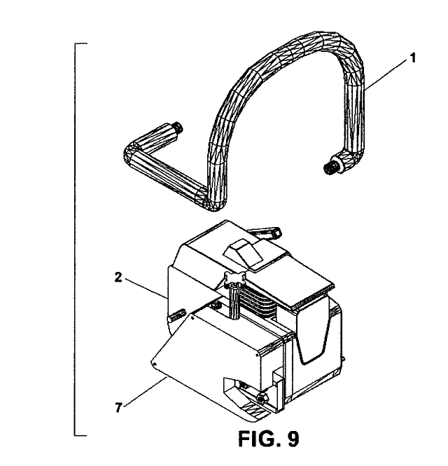

FIG. 9 is a right sectional view of the bar handle 1 in relation to the chainsaw body. The bar handle 1 forms a symmetrical loop from the attachment point on the left side of the saw, up over the top of the saw and down the right side till the length of the bar is the same distance on both sides of the saw. The bar handle 1 then turn 90 degrees back and 90 degrees left and attach's to the right side of the saw. The symmetrical loop on the bar handle 1 will aid the operator in making angled cuts by giving him basically the same grip on the bar handle 1 by allowing him to slide his hand on a symmetrical equal distant bar as the saw is rotated incrementally either right or left.

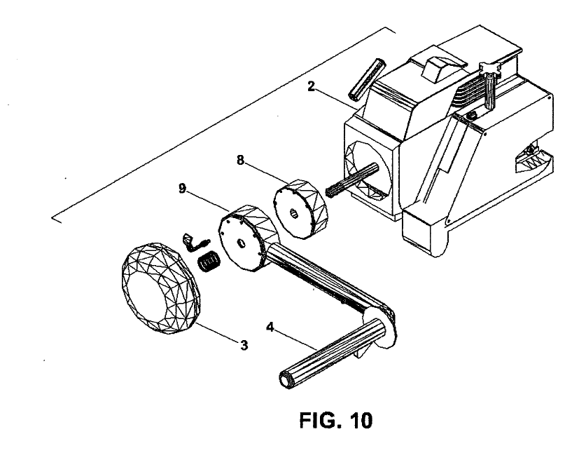

FIG. 10 is a rear exploded view of the incremental rotational control 9 components, rear handle 4 with throttle control 13, and torso pad 3 in relation to where they connect onto the saw body 2 via a shaft that extends from the body frame. The incremental rotational control 9 consist of a pinwheel 8 that connects onto a solid shaft extending back from the engine frame, and a sleeve that fits over it to which the rear handle 4 attaches. The pinwheel 8 has five shallow holes drilled in it that represent the five settings of the incremental rotational control 9. One hole is at zero degrees top dead center, one at forty five degrees right, one at ninety degrees right, one at two hundred seventy degrees left, and one at three hundred fifteen degrees left. When the spring loaded pin 10 on the incremental rotational control 9 is at zero degrees top, the saw is aligned straight, and the rear handle 4 is positioned to the right. The rear handle 4 remains in that position as the incremental rotational control 9 is adjusted forty five and ninety degrees right or left when the operator presses the pin and rotates the saw body 2. The spring loaded pin 10 is bullet shaped so that when it reaches the holes in the pinwheel 8, it snaps into each hole and is secured there by the pressure of the spring loaded pin 10.

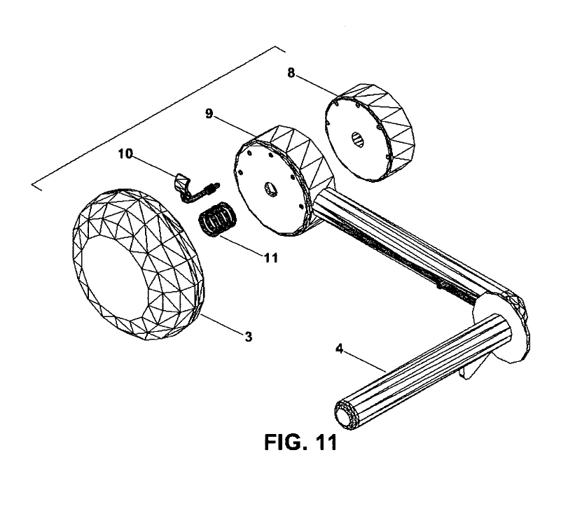

FIG. 11 is a rear exploded view of the incremental rotational control 9 components, rear handle 4 with throttle control 13, and torso pad 3. The spring loaded pin 10 called out on this view as well as the torso pad pin spring 11. The torso pad 3 pin and spring has approximately three inches of travel to counter vibration, and any kickback motions of the saw against the torso.

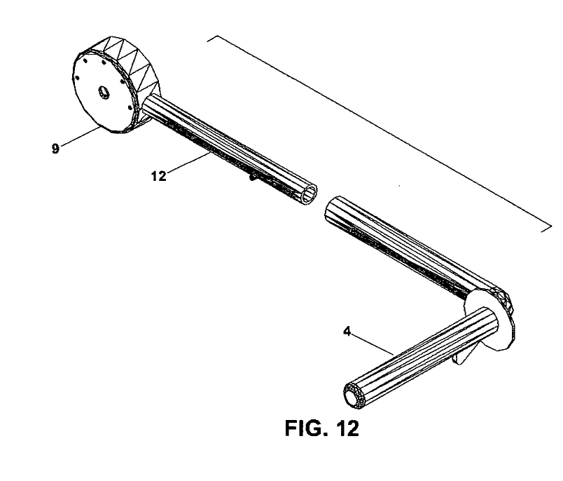

FIG. 12 is a detail view of the two rear handle 4 sections with the inside section of the rear handle 12 shown connected to the incremental rotational control 9. The outside section of the rear handle 4 sleeves into the inside section of the rear handle 12 and is adjusted by depressing the spring pin on the handle 14 and sliding the outside section to the desired length, then allowing the spring pin to pop through one of the adjustment holes in the outside section of the rear handle 4.

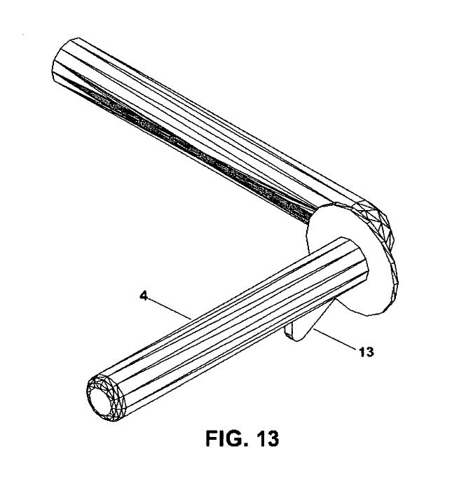

FIG. 13 is a detail view of the outside section of the rear handle 4 and throttle control 13. The adjustment holes in the outside section of the rear handle 4 are visible. The throttle control 13 is connected to a flex control cable which runs inside the rear handle 4 and through the incremental rotational control 9 and exits very close to center, and into the saw body 2. This alignment allows for the saw body 2 rotation via the incremental rotational control 9. The flex control cable will have enough slack inside the rear handle 4 to allow for adjustments of the handle length.

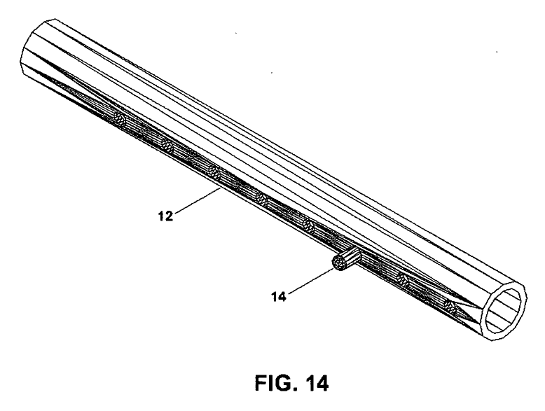

FIG. 14 is a detail view of the inside section of the rear handle 12 showing the adjustment holes and spring pin.

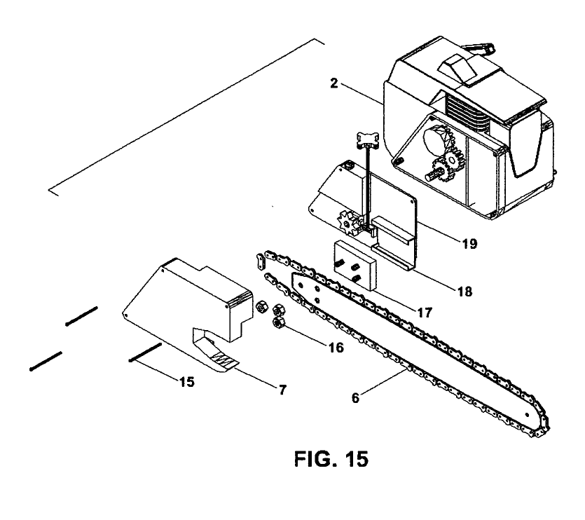

FIG. 15 is a exploded view of the gearbox, mechanical gears, oil environment centrifugal clutch 24, gearbox reservoir cover plate 19, gearbox oil fill cap 26, chain tension adjustment mechanism 25, guide bar mounting plate 17, guide bar 6 plate adjustment slot, guide bar 6 and chain, gearbox cover 7, and gearbox cover mounting screws 15. The gearbox serves three purposes. One, it protects the mechanical gears and the oil environment centrifugal clutch 24 from debris and damage from the environment. Two, it provides an attachment point for the chain tension adjustment mechanism 25. Three, it provides an attachment point for the guide bar 6 plate adjustment slot. The gears are set as follows. The upper mechanical gear 23 is welded onto the oil environment centrifugal clutch 24 hub. The gears do not spin to drive the chain until the RPM's are increased sufficiently to activate the clutch. The upper mechanical gear 23 turns the same direction of the engine drive shaft, clockwise. The upper mechanical gear 23 turns the middle mechanical gear 22 counter clockwise, which turns the lower mechanical gear 21 counter clockwise. The lower mechanical gear 21 rides on a shaft that extends outside the gearbox through a seal in the gearbox reservoir cover plate 19. The chain sprocket 20 is attached onto this shaft. The shaft turns the same direction as the upper mechanical gear 23, pulling the bottom of the chain toward the saw. The purpose of the gear arrangement is to lower the chain sprocket 20 and guide bar 6 sufficiently so that the chain sets approximately 3/32 of an inch above the anti-kickback/cut through device 5 bar. This in turn positions the bar at a lower point, making it easier for the operator to slide the anti-kickback/cut through device 5 under logs on the ground.

The guide bar mounting plate 17 has three studs in a triangular pattern to fit the holes on the guide bar 6 itself. The guide bar 6 is bolted onto the guide bar mounting plate 17 and the guide bar mounting plate 17 is inserted into the guide bar 6 plate adjustment slot, which is located on the lower front of the gearbox reservoir cover plate 19. The guide bar mounting plate 17 then slides as close as possible to the chain sprocket 20, and the chain is looped over the sprocket. The chain tension adjustment mechanism 25 is then used to adjust the tension on the chain by pushing the guide bar mounting plate 17 until the correct tension is achieved. The gearbox cover 7 is then screwed into place to protect gearbox, as well as the the chain sprocket 20 and chain tension adjustment mechanism 25 from debris.

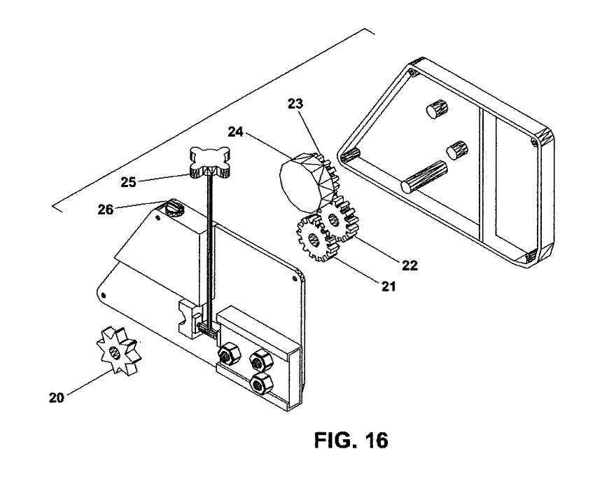

FIG. 16 is an exploded detail view of the gearbox, mechanical gears, oil environment centrifugal clutch 24, chain tension adjustment mechanism 25, guide bar mounting plate 17 setting in the guide bar 6 plate adjustment slot, the oil fill cap, and the chain sprocket 20. FIG. 16 is very much like FIG. 15, with the exceptions of the gears exploded out so the shaft arrangement is visible, and the guide bar mounting plate 17 is shown inserted into the guide bar 6 adjustment slot.

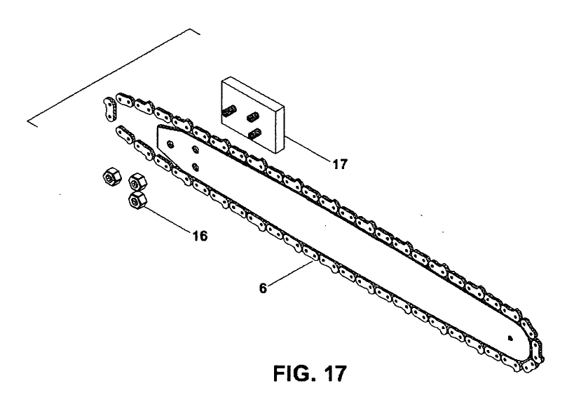

FIG. 17 is a detail view of the guide bar mounting plate 17, guide bar 6 and chain, and the guide bar mounting plate nuts 16 This gives a detail view of how the guide bar 6 and chain will mount onto the guide bar mounting plate 17.

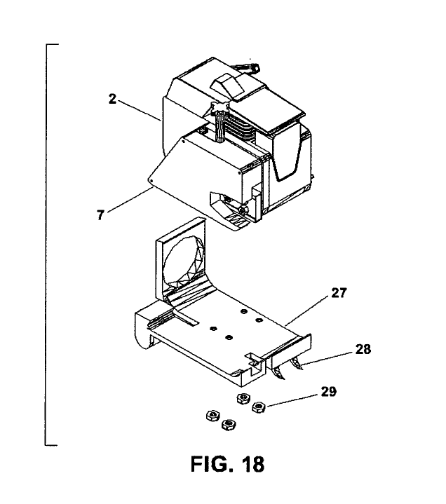

FIG. 18 is a sectional view of the bottom mold 27 and the saw body 2 to which it attaches. The bottom mold 27 sill be made of a hard plastic. This mold may be formed in in one of two ways. One, via a molded frame, as shown, which will be bolted onto undercarriage of the body of the saw. Two, via a mold which will be incorporated into the body of the saw itself by the manufacturer. For the purpose of this presentation, the drawings illustrate a molded frame that attaches to the bottom of an existing chainsaw. The drawing shows the gearbox cover 7 attached to the saw body 2, the forward facing spikes on the bottom mold 28, and the bottom mold nuts 29, with which it is attached to the saw body 2.

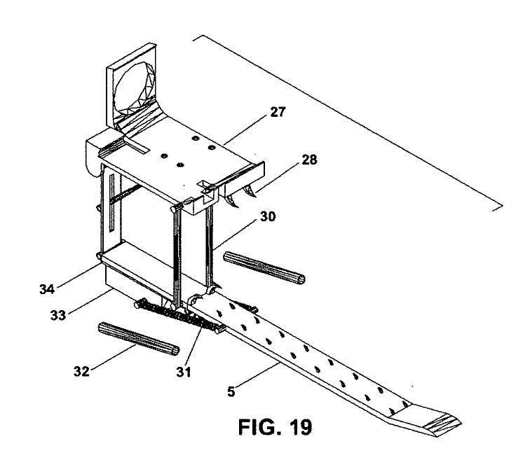

FIG. 19 is a detail view of the bottom mold 27 with stage one of the anti-kickback/cut through device 5 deployed. In this view the compression springs 31 are visible as the the compression spring protector sleeves 32 are exploded out.

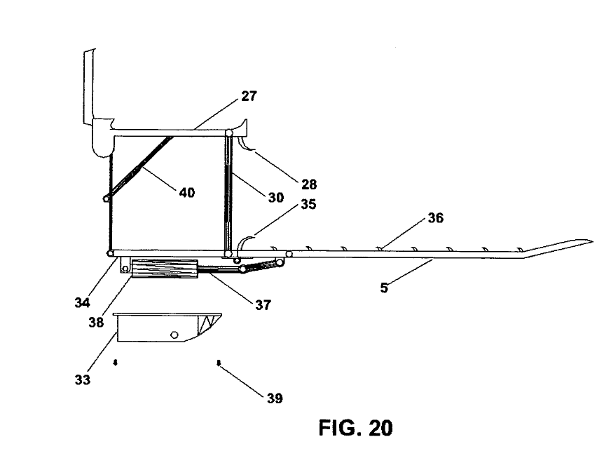

FIG. 20 is a detail side view of the bottom mold 27 with stage one of the anti-kickback/cut through device 5 deployed. The ambient air cylinder/flow control valve 37 is visible as the ambient air cylinder/flow control valve cover 33 is exploded out. The anti-kickback/cut through device 5 telescoping back stop rod 40 is visible. The telescoping back stop rod 40 is shown fully deployed into a forty five degree angle from the bottom mold 27 to the center of the spiral wound torsion spring 41 connector.

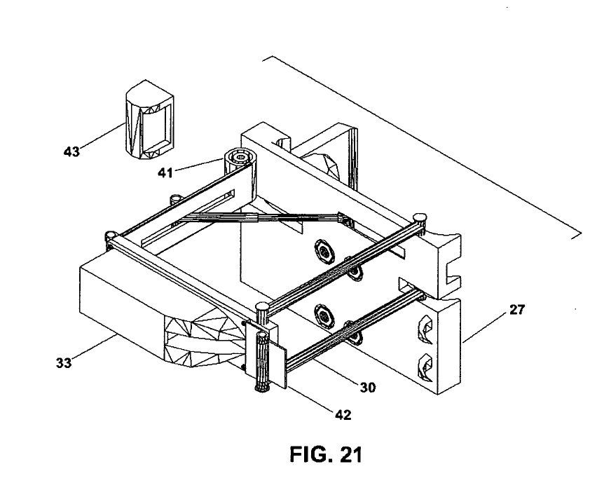

FIG. 21 is a bottom detail view of the bottom mold 27, rear section of the anti-kickback/cut through device 5 bar, The anti-kickback/cut through device bar hinge 42, telescoping back stop rod 40 is connected to the bottom mold 27 via small plate mounted into a slot that allows it the proper travel distance. When stage one of the anti-kickback/cut through device 5 closes, the telescoping back stop rod 40 connection in the bottom mold 27 slides forward, while at the same time, the telescoping rod closes to it's shortest length and lays into the slot inside the bottom mold 27 behind the sliding plate. The spiral wound torsion spring canister 43 is exploded to give a view of the spiral wound torsion spring 41. However it should be noted that the spiral wound torsion spring canister 43 is part of the bottom mold 27.

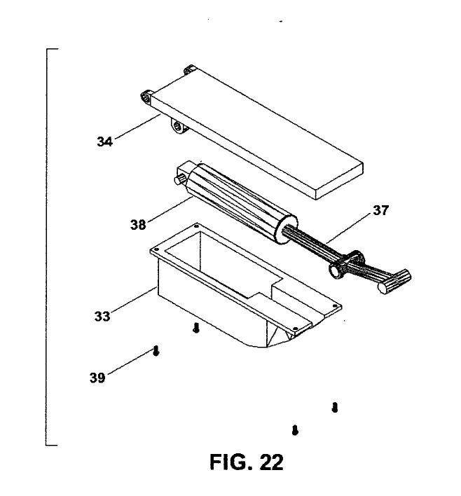

FIG. 22 is an exploded view of the ambient air cylinder/flow control valve 37 and ambient air cylinder/flow control valve cover mounting screws 39, and the rear section of the anti-kickback/cut through device 5 bar to which it attaches. The ambient air cylinder/flow control valve pivot mount 38 is also shown.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A kct injury prevention chain saw for a “kct injury prevention chain saw” for: reducing or eliminating cut through and kick back injuries associated with chainsaw operations, comprising:
means for the operator to grip the handle in the same way no matter which degree of direction the saw body is turned;
means for the operator to bring the back of the saw against his torso;
means for provision of an ergonomic grip for the operator and keep the saw straight away forward from the operator, rigidly connected to said means for the operator to bring the back of the saw against his torso;
means for prevention of kickback and cut through injuries;
means for for quick adjustment of the chain;
means for provision of a protective cover for the gearbox and chain adjustment mechanism;
means for the operator to change the angle of the saw either 45 or 90 degrees right or left while keeping the handles and grip in the same position when making angled cuts, rigidly connected to said means for provision of an ergonomic grip for the operator and keep the saw straight away forward from the operator;
means for locking the incremental rotational control at various angles in order to make angled cuts, rigidly connected to said means for the operator to change the angle of the saw either 45 or 90 degrees right or left while keeping the handles and grip in the same position when making angled cuts;
means for attaching the guide bar to it, rigidly connected to said means for for quick adjustment of the chain;
means for the guide bar plate to slide into/back and forth for easy chain tension adjustment, rigidly connected to said means for attaching the guide bar to it;
means for sealing the gearbox and protecting the oil environment centrifugal clutch and mechanical gears, rigidly connected to said means for the guide bar plate to slide into/back and forth for easy chain tension adjustment;
means for turning the shaft that turns the chain sprocket;
means for transfer of power to the lower gear from the upper gear, rigidly connected to said means for turning the shaft that turns the chain sprocket;
means for transfer of power from the engine through the gear box system, rigidly connected to said means for transfer of power to the lower gear from the upper gear;
means for stopping power transfer from the engine when the chain binds, rigidly connected to said means for transfer of power from the engine through the gear box system;
means for providing an easy adjustment of the chain, rigidly connected to said means for provision of a protective cover for the gearbox and chain adjustment mechanism, and rigidly connected to said means for for quick adjustment of the chain;
means for providing a platform for mounting the incremental rotational control and the anti-kickback/cut through device;
means for keeping items being cut from impeding operation of the anti-kickback/cut through device. and provide a pivot point the operator can use to rock the saw on during cutting in order to clear debris from the chain, rigidly connected to said means for providing a platform for mounting the incremental rotational control and the anti-kickback/cut through device;
means for the first stage of the anti-kickback/cut through device to pivot down and back when deployed;
means for pushing the anti-kickback/cut through device back up into position when stage two is deployed;
means for protecting the compression springs from damage and debris, rigidly connected to said means for pushing the anti-kickback/cut through device back up into position when stage two is deployed, and rigidly connected to said means for prevention of kickback and cut through injuries;
means for protecting the ambient air cylinder/flow control valve from damage;
means for the anti-kickback/cut through device bar to hinge open and closed as stage one is deployed, rigidly connected to said means for prevention of kickback and cut through injuries;
means for preventing items being cut from contacting the hinge connector rods and damaging them or impeding the operation of same, rigidly connected to said means for prevention of kickback and cut through injuries;
means for holding the item being cut in place when kickback occurs, rigidly connected to said means for preventing items being cut from contacting the hinge connector rods and damaging them or impeding the operation of same;
means for seizing the anti-kickback device when a sudden pressure is applied during a kickback event, rigidly connected to said means for protecting the ambient air cylinder/flow control valve from damage, and rigidly connected to said means for pushing the anti-kickback/cut through device back up into position when stage two is deployed;
means for mounting the rear of the ambient air cylinder/flow control valve so that it pivots when stage two of the anti-kickback/cut through device is deployed, rigidly connected to said means for protecting the ambient air cylinder/flow control valve from damage;
means for closing stage one of the anti-kickback/cut through device when it is deployed, rigidly connected to said means for the anti-kickback/cut through device bar to hinge open and closed as stage one is deployed;
means for protecting the spiral wound torsion spring, rigidly connected to said means for closing stage one of the anti-kickback/cut through device when it is deployed;
means for preventing the anti-kick/cut through device from swinging further back than it was designed, rigidly connected to said means for closing stage one of the anti-kickback/cut through device when it is deployed, rigidly connected to said means for the first stage of the anti-kickback/cut through device to pivot down and back when deployed, rigidly connected to said means for providing a platform for mounting the incremental rotational control and the anti-kickback/cut through device, and rigidly connected to said means for prevention of kickback and cut through injuries;
means for rotating the chainsaw incrementally as the pin is transferred between the holes in the pinwheel, rigidly connected to said means for the operator to change the angle of the saw either 45 or 90 degrees right or left while keeping the handles and grip in the same position when making angled cuts, and rigidly connected to said means for the operator to grip the handle in the same way no matter which degree of direction the saw body is turned;
means for the torso pad to flex when the saw kicks back during cutting operations;
means for the outside adjustable section of the rear handle to slide into when being adjusted and to lock when adjustment is complete;
means for controlling the engine speed;
means for adjusting the rear handle length;
means for securing the gearbox cover to the gearbox; and
means for opening and closing stage two of the anti-kickback/cut through device bar.

2. The kct injury prevention chain saw in accordance with claim 1, wherein said means for the operator to grip the handle in the same way no matter which degree of direction the saw body is turned comprises a bar handle.

3. The kct injury prevention chain saw in accordance with claim 1, wherein said means for the operator to bring the back of the saw against his torso comprises a torso pad.

4. The kct injury prevention chain saw in accordance with claim 1, wherein said means for provision of an ergonomic grip for the operator and keep the saw straight away forward from the operator comprises a rear handle.

5. The kct injury prevention chain saw in accordance with claim 1, wherein said means for prevention of kickback and cut through injuries comprises an anti-kickback/cut through device.

6. The kct injury prevention chain saw in accordance with claim 1, wherein said means for for quick adjustment of the chain comprises a guide bar.

7. The kct injury prevention chain saw in accordance with claim 1, wherein said means for provision of a protective cover for the gearbox and chain adjustment mechanism comprises a gearbox cover.

8. The kct injury prevention chain saw in accordance with claim 1, wherein said means for the operator to change the angle of the saw either 45 or 90 degrees right or left while keeping the handles and grip in the same position when making angled cuts comprises an incremental rotational control.

9. The kct injury prevention chain saw in accordance with claim 1, wherein said means for locking the incremental rotational control at various angles in order to make angled cuts comprises a spring loaded pin.

10. The kct injury prevention chain saw in accordance with claim 1, wherein said means for attaching the guide bar to it comprises a guide bar mounting plate.

11. The kct injury prevention chain saw in accordance with claim 1, wherein said means for the guide bar plate to slide into/back and forth for easy chain tension adjustment comprises a guide bar plate adjusting slot.

12. The kct injury prevention chain saw in accordance with claim 1, wherein said means for sealing the gearbox and protecting the oil environment centrifugal clutch and mechanical gears comprises a gearbox reservoir cover plate.

13. The kct injury prevention chain saw in accordance with claim 1, wherein said means for turning the shaft that turns the chain sprocket comprises a lower mechanical gear.

14. The kct injury prevention chain saw in accordance with claim 1, wherein said means for transfer of power to the lower gear from the upper gear comprises a middle mechanical gear.

15. The kct injury prevention chain saw in accordance with claim 1, wherein said means for transfer of power from the engine through the gear box system comprises an upper mechanical gear.

16. The kct injury prevention chain saw in accordance with claim 1, wherein said means for stopping power transfer from the engine when the chain binds comprises an oil environment centrifugal clutch.

17. The kct injury prevention chain saw in accordance with claim 1, wherein said means for providing an easy adjustment of the chain comprises a chain tension adjustment mechanism.

18. The kct injury prevention chain saw in accordance with claim 1, wherein said means for providing a platform for mounting the incremental rotational control and the anti-kickback/cut through device comprises a bottom mold.

19. The kct injury prevention chain saw in accordance with claim 1, wherein said means for keeping items being cut from impeding operation of the anti-kickback/cut through device. and provide a pivot point the operator can use to rock the saw on during cutting in order to clear debris from the chain comprises a forward facing spikes on the bottom mold.

20. The kct injury prevention chain saw in accordance with claim 1, wherein said means for the first stage of the anti-kickback/cut through device to pivot down and back when deployed comprises a front hinge connector rods.

21. The kct injury prevention chain saw in accordance with claim 1, wherein said means for pushing the anti-kickback/cut through device back up into position when stage two is deployed comprises a compression springs.

22. The kct injury prevention chain saw in accordance with claim 1, wherein said means for protecting the compression springs from damage and debris comprises a compression spring protector sleeves.

23. The kct injury prevention chain saw in accordance with claim 1, wherein said means for protecting the ambient air cylinder/flow control valve from damage comprises an ambient air cylinder/flow control valve cover.

24. The kct injury prevention chain saw in accordance with claim 1, wherein said means for the anti-kickback/cut through device bar to hinge open and closed as stage one is deployed comprises an anti-kickback/cut through device rear bar hinge.

25. The kct injury prevention chain saw in accordance with claim 1, wherein said means for preventing items being cut from contacting the hinge connector rods and damaging them or impeding the operation of same comprises a forward facing spikes on anti-kickback/cut through bar.

26. The kct injury prevention chain saw in accordance with claim 1, wherein said means for holding the item being cut in place when kickback occurs comprises a rear facing dorsal spikes on the anti-kickback/cut through device bar.

27. The kct injury prevention chain saw in accordance with claim 1, wherein said means for seizing the anti-kickback device when a sudden pressure is applied during a kickback event comprises an ambient air cylinder/flow control valve.

28. The kct injury prevention chain saw in accordance with claim 1, wherein said means for mounting the rear of the ambient air cylinder/flow control valve so that it pivots when stage two of the anti-kickback/cut through device is deployed comprises an ambient air cylinder/flow control valve pivot mount.

29. The kct injury prevention chain saw in accordance with claim 1, wherein said means for closing stage one of the anti-kickback/cut through device when it is deployed comprises a spiral wound torsion spring.

30. The kct injury prevention chain saw in accordance with claim 1, wherein said means for protecting the spiral wound torsion spring comprises a spiral wound torsion spring canister.

31. The kct injury prevention chain saw in accordance with claim 1, wherein said means for preventing the anti-kick/cut through device from swinging further back than it was designed comprises a telescoping back stop rod.

32. The kct injury prevention chain saw in accordance with claim 1, wherein said means for rotating the chainsaw incrementally as the pin is transferred between the holes in the pinwheel comprises a pinwheel.

33. The kct injury prevention chain saw in accordance with claim 1, wherein said means for the torso pad to flex when the saw kicks back during cutting operations comprises a torso pad pin spring.

34. The kct injury prevention chain saw in accordance with claim 1, wherein said means for the outside adjustable section of the rear handle to slide into when being adjusted and to lock when adjustment is complete comprises the inside section of the rear handle.

35. The kct injury prevention chain saw in accordance with claim 1, wherein said means for controlling the engine speed comprises a throttle control.

36. The kct injury prevention chain saw in accordance with claim 1, wherein said means for adjusting the rear handle length comprises a spring pin on the inside section of handle.

37. The kct injury prevention chain saw in accordance with claim 1, wherein said means for securing the gearbox cover to the gearbox comprises a gearbox cover mounting screws.

38. The kct injury prevention chain saw in accordance with claim 1, wherein said means for opening and closing stage two of the anti-kickback/cut through device bar comprises an anti-kickback/cut through device bar hinge.

39. A kct injury prevention chain saw for a “kct injury prevention chain saw” for: reducing or eliminating cut through and kick back injuries associated with chainsaw operations, comprising:
a bar handle, for the operator to grip the handle in the same way no matter which degree of direction the saw body is turned;
a torso pad, for the operator to bring the back of the saw against his torso;
a rear handle, for provision of an ergonomic grip for the operator and keep the saw straight away forward from the operator, rigidly connected to said torso pad;
an anti-kickback/cut through device, for prevention of kickback and cut through injuries;
a guide bar, for for quick adjustment of the chain;
a gearbox cover, for provision of a protective cover for the gearbox and chain adjustment mechanism;
an incremental rotational control, for the operator to change the angle of the saw either 45 or 90 degrees right or left while keeping the handles and grip in the same position when making angled cuts, rigidly connected to said rear handle;
a spring loaded pin, for locking the incremental rotational control at various angles in order to make angled cuts, rigidly connected to said incremental rotational control;
a guide bar mounting plate, for attaching the guide bar to it, rigidly connected to said guide bar;
a guide bar plate adjusting slot, for the guide bar plate to slide into/back and forth for easy chain tension adjustment, rigidly connected to said guide bar mounting plate;
a gearbox reservoir cover plate, for sealing the gearbox and protecting the oil environment centrifugal clutch and mechanical gears, rigidly connected to said guide bar plate adjusting slot;
a lower mechanical gear, for turning the shaft that turns the chain sprocket;
a middle mechanical gear, for transfer of power to the lower gear from the upper gear, rigidly connected to said lower mechanical gear;
an upper mechanical gear, for transfer of power from the engine through the gear box system, rigidly connected to said middle mechanical gear;
an oil environment centrifugal clutch, for stopping power transfer from the engine when the chain binds, rigidly connected to said upper mechanical gear;
a chain tension adjustment mechanism, for providing an easy adjustment of the chain, rigidly connected to said gearbox cover, and rigidly connected to said guide bar;
a bottom mold, for providing a platform for mounting the incremental rotational control and the anti-kickback/cut through device;
a forward facing spikes on the bottom mold, for keeping items being cut from impeding operation of the anti-kickback/cut through device. and provide a pivot point the operator can use to rock the saw on during cutting in order to clear debris from the chain, rigidly connected to said bottom mold;
a front hinge connector rods, for the first stage of the anti-kickback/cut through device to pivot down and back when deployed;
a compression springs, for pushing the anti-kickback/cut through device back up into position when stage two is deployed;
a compression spring protector sleeves, for protecting the compression springs from damage and debris, rigidly connected to said compression springs, and rigidly connected, to said anti-kickback/cut through device;
an ambient air cylinder/flow control valve cover, for protecting the ambient air cylinder/flow control valve from damage;
an anti-kickback/cut through device rear bar hinge, for the anti-kickback/cut through device bar to hinge open and closed as stage one is deployed, rigidly connected to said anti-kickback/cut through device;
a forward facing spikes on anti-kickback/cut through bar, for preventing items being cut from contacting the hinge connector rods and damaging them or impeding the operation of same, rigidly connected to said anti-kickback/cut through device;
a rear facing dorsal spikes on the anti-kickback/cut through device bar, for holding the item being cut in place when kickback occurs, rigidly connected to said forward facing spikes on anti-kickback/cut through bar;
an ambient air cylinder/flow control valve, for seizing the anti-kickback device when a sudden pressure is applied during a kickback event, rigidly connected to said ambient air cylinder/flow control valve cover, and rigidly connected to said compression springs;
an ambient air cylinder/flow control valve pivot mount, for mounting the rear of the ambient air cylinder/flow control valve so that it pivots when stage two of the anti-kickback/cut through device is deployed, rigidly connected to said ambient air cylinder/flow control valve cover;
a spiral wound torsion spring, for closing stage one of the anti-kickback/cut through device when it is deployed, rigidly connected to said anti-kickback/cut through device rear bar hinge;
a spiral wound torsion spring canister, for protecting the spiral wound torsion spring, rigidly connected to said spiral wound torsion spring;
a telescoping back stop rod, for preventing the anti-kick/cut through device from swinging further back than it was designed, rigidly connected to said spiral wound torsion spring, rigidly connected to said front hinge connector rods, rigidly connected to said bottom mold, and rigidly connected to said anti-kickback/cut through device;
a pinwheel, for rotating the chainsaw incrementally as the pin is transferred between the holes in the pinwheel, rigidly connected to said incremental rotational control, and rigidly connected to said bar handle;
a torso pad pin spring, for the torso pad to flex when the saw kicks back during cutting operations;
the inside section of the rear handle, for the outside adjustable section of the rear handle to slide into when being adjusted and to lock when adjustment is complete;
a throttle control, for controlling the engine speed;
a spring pin on the inside section of handle, for adjusting the rear handle length;
a gearbox cover mounting screws, for securing the gearbox cover to the gearbox; and
an anti-kickback/cut through device bar hinge, for opening and closing stage two of the anti-kickback/cut through device bar.

40. A kct injury prevention chain saw for a “kct injury prevention chain saw” for: reducing or eliminating cut through and kick back injuries associated with chainsaw operations, comprising:
a bar handle, for the operator to grip the handle in the same way no matter which degree of direction the saw body is turned;
a torso pad, for the operator to bring the back of the saw against his torso;
a rear handle, for provision of an ergonomic grip for the operator and keep the saw straight away forward from the operator, rigidly connected to said torso pad;
an anti-kickback/cut through device, for prevention of kickback and cut through injuries;
a guide bar, for for quick adjustment of the chain;
a gearbox cover, for provision of a protective cover for the gearbox and chain adjustment mechanism;
an incremental rotational control, for the operator to change the angle of the saw either 45 or 90 degrees right or left while keeping the handles and grip in the same position when making angled cuts, rigidly connected to said rear handle;
a spring loaded pin, for locking the incremental rotational control at various angles in order to make angled cuts, rigidly connected to said incremental rotational control;
a guide bar mounting plate, for attaching the guide bar to it, rigidly connected to said guide bar;
a guide bar plate adjusting slot, for the guide bar plate to slide into/back and forth for easy chain tension adjustment, rigidly connected to said guide bar mounting plate;
a gearbox reservoir cover plate, for sealing the gearbox and protecting the oil environment centrifugal clutch and mechanical gears, rigidly connected to said guide bar plate adjusting slot;
a lower mechanical gear, for turning the shaft that turns the chain sprocket;
a middle mechanical gear, for transfer of power to the lower gear from the upper gear, rigidly connected to said lower mechanical gear;
an upper mechanical gear, for transfer of power from the engine through the gear box system, rigidly connected to said middle mechanical gear;
an oil environment centrifugal clutch, for stopping power transfer from the engine when the chain binds, rigidly connected to said upper mechanical gear;
a chain tension adjustment mechanism, for providing an easy adjustment of the chain, rigidly connected to said gearbox cover, and rigidly connected to said guide bar;
a bottom mold, for providing a platform for mounting the incremental rotational control and the anti-kickback/cut through device;
a forward facing spikes on the bottom mold, for keeping items being cut from impeding operation of the anti-kickback/cut through device. and provide a pivot point the operator can use to rock the saw on during cutting in order to clear debris from the chain, rigidly connected to said bottom mold;
a front hinge connector rods, for the first stage of the anti-kickback/cut through device to pivot down and back when deployed;
a compression springs, for pushing the anti-kickback/cut through device back up into position when stage two is deployed;
a compression spring protector sleeves, for protecting the compression springs from damage and debris, rigidly connected to said compression springs, and rigidly connected to said anti-kickback/cut through device;
an ambient air cylinder/flow control valve cover, for protecting the ambient air cylinder/flow control valve from damage;
an anti-kickback/cut through device rear bar hinge, for the anti-kickback/cut through device bar to hinge open and closed as stage one is deployed, rigidly connected to said anti-kickback/cut through device;
a forward facing spikes on anti-kickback/cut through bar, for preventing items being cut from contacting the hinge connector rods and damaging them or impeding the operation of same, rigidly connected to said anti-kickback/cut through device;
a rear facing dorsal spikes on the anti-kickback/cut through device bar, for holding the item being cut in place when kickback occurs, rigidly connected to said forward facing spikes on anti-kickback/cut through bar;
an ambient air cylinder/flow control valve, for seizing the anti-kickback device when a sudden pressure is applied during a kickback event, rigidly connected to said ambient air cylinder/flow control valve cover, and rigidly connected to said compression springs;
an ambient air cylinder/flow control valve pivot mount, for mounting the rear of the ambient air cylinder/flow control valve so that it pivots when stage two of the anti-kickback/cut through device is deployed, rigidly connected to said ambient air cylinder/flow control valve cover;
a spiral wound torsion spring, for closing stage one of the anti-kickback/cut through device when it is deployed, rigidly connected to said anti-kickback/cut through device rear bar hinge;
a spiral wound torsion spring canister, for protecting the spiral wound torsion spring, rigidly connected to said spiral wound torsion spring;
a telescoping back stop rod, for preventing the anti-kick/cut through device from swinging further back than it was designed, rigidly connected to said spiral wound torsion spring, rigidly connected to said front hinge connector rods, rigidly connected to said bottom mold, and rigidly connected to said anti-kickback/cut through device;
a pinwheel, for rotating the chainsaw incrementally as the pin is transferred between the holes in the pinwheel, rigidly connected to said incremental rotational control, and rigidly connected to said bar handle;
a torso pad pin spring, for the torso pad to flex when the saw kicks back during cutting operations;
the inside section of the rear handle, for the outside adjustable section of the rear handle to slide into when being adjusted and to lock when adjustment is complete;
a throttle control, for controlling the engine speed;
a spring pin on the inside section of handle, for adjusting the rear handle length;
a gearbox cover mounting screws, for securing the gearbox cover to the gearbox; and
an anti-kickback/cut through device bar hinge, for opening and closing stage two of the anti-kickback/cut through device bar.
